(19) United States
(12) Patent Application Publication
(10) Pub. No.: US 2022/0289460 A1
(43) Pub. Date: Sep. 15, 2022

(54) THERMAL CONTAINER FOR TRANSPORTING HOT FAST FOOD

(71) Applicant: FOODHAVEN, S.L., Barcelona (ES)

(72) Inventors: Jose Maria FABREGAT OLLE, Barcelona (ES); Carolina FABREGAT OLLE, Barcelona (ES); Adrian SATUE MARTINEZ, Barcelona (ES)

(21) Appl. No.: 17/638,940

(22) PCT Filed: Aug. 28, 2020
(86) PCT No.: PCT/ES2020/070525

§ 371 Date: Feb. 28, 2022

(30) Foreign Application Priority Data
Aug. 28, 2019 (ES) U201931418

(51) Int. Cl. B65D 81/34; A47J 47/14; B65D 81/26; B65D 5/00; F28D 20/00

(52) U.S. Cl. CPC B65D 81/3484; A47J 47/14; B65D 81/263; B65D 5/00; F28D 20/0056; F28D 2020/0026

(57) ABSTRACT

A thermal container for transporting hot fast food having a body that forms a main box which defines an internal space for the food, includes on the inside an internal receptacle for incorporating heat emitters and a double ventilation system for circulating air between the internal receptacle and the internal space, allowing the heat from the heat emitters to circulate towards the food, keeping it warm, and aeration towards the outside, avoiding steam condensation. The double ventilation system has internal air circulation slots in the internal receptacle and external ventilation slots and holes in the main box. The internal receptacle can be a separate box from the main box which fits over the inner base of the main box.

### PURPOSE OF THE INVENTION

The invention, as expressed in the heading of this descriptive report, refers to a thermal container for the transport of hot fast food, which provides, in its intended use, the advantages and characteristics that are described below in detail, which signify an improvement in the current state of the art within its field of application.

More specifically, the purpose of the invention is centred on a container, preferably of a single use, for example such as those made from a pre-cut laminated body folded into the shape of a box, normally of cardboard, which being intended to be used for the transport of fast food products for takeout or home delivery, specifically, hot food, for example, hamburgers. It is distinguished by including an internal receptacle, preferable also in the form of a box, which is specifically designed to incorporate means for emitting heat, preferably hot stones, which preserve the heat within the container and keep the food hot. In addition, the container also has ventilation means designed to facilitate the circulation of the air and, in turn, avoid the formation of steam that can degrade the food.

### INVENTION'S FIELD OF APPLICATION

The field of application of this invention is framed within the sector of the industry dedicated to the manufacturing of containers for food products, focussing particularly on the area of single-use containers of cardboard or similar laminated material.

### BACKGROUND OF THE INVENTION

Currently, the marketing of food known as “fast food” is becoming more frequent, which, in addition to being able to be consumed in the establishment itself, can be taken out or delivered to the home, either as a service of the establishment itself or else through a delivery company, with the second being an increasingly more extended option. In any case, the food is usually placed in single-use containers, normally of cardboard or similar, which keep it in conditions of hygiene and temperature at low cost.

However, especially when it deals with hot food, such as, for example, the case of hamburgers, the existing cardboard containers do not present an optimal solution for the preservation of the temperature and the food ends up arriving to the consumer warm or cold.

On the other hand, although some thermal containers are known which do offer a better guarantee of maintaining the temperature of their contents; they normally deal with containers manufactured with thick walls that include insulating materials, which, besides raising the manufacturing cost enormously for it to be a product apt for a single use, are only designed to insulate the interior from the exterior temperature and, in addition, are usually used to maintain the coldness of the products they contain.

Therefore, the objective of this invention is to provide the market with a new type of single-use container that, without a special increase in its manufacturing cost, will provide a simple, practical and effective means to carry hot fast food, maintaining its temperature during the entire route that its transport lasts from the establishment in which it is cooked to the home where it is consumed, also managing for the steam that the food itself produces by being hot not degrading it due to its getting wet.

Furthermore, and as reference to the current state of the art, it should be mentioned that, at least for the applicant, the existence of any other thermal container, or any other similar invention is not known, that presents some technical, structural and constitutive characteristics equal or similar to those claimed by this invention.

### EXPLANATION OF THE INVENTION

The thermal container for the transport of hot fast food that the invention proposes allows achieving satisfactorily the objectives indicated above, with the characterising details that make it possible and that distinguish it appropriately being included in the final claims that accompany this description.

Specifically, what the invention proposes, as indicated above, is a container designed to be used to transport fast food products for takeout or home delivery, in particular, hot food, such as, for example, hamburgers, although without being limited to this, which is distinguished by presenting the particularity of including in its interior an internal receptacle that is specifically provided to incorporate heat emitters, preferably hot stones, with which it manages to preserve the heat of the container and, consequently, keep the food hot.

Furthermore, the container also has a studied double ventilation system designed, on the one hand, to facilitate the circulation of the air inside it, helping the heat from the hot stones or heat emitters that it incorporates to circulate towards the food, keeping it at the correct temperature, and on the other hand, to facilitate the aeration of the steam that, logically, the hot food releases, towards the exterior of the container and thus avoiding this steam condensing within the container and degrading the food by its becoming wet by the formed humidity.

Specifically, this double ventilation system is defined, on the one hand, by a series of internal air circulation slots, provided in the internal receptacle in order to communicate the interior of the latter with the interior of the main box of the container and permit the circulation of hot air and, on the other hand, a series of external aeration slots and perforations provided in the walls of the main box that communicates its interior with the exterior in order to allow the exit of the steam to the exterior.

Preferably, the container is of single use, for example, such as those formed from a pre-cut laminated body and folded into the box shape, where this box, which we will refer to as the main box, in order to contain the food and the internal receptacle where the heat emitters are incorporated, can be of the same material, for example, of cardboard, or of different materials.

In at least one form of embodiment, the main box that forms the thermal container is of cardboard, while the internal receptacle can be of another different material. And, in another form of embodiment, both the main box of the container and the internal receptacle are of the same material, preferably of cardboard.

Moreover, in the form of the preferred embodiment, the internal receptacle is also a laminated body folded into a box shape that is placed on the internal base of the main box that makes up the container, but with a notably inferior height, with its upper base defining the support surface on which the food is placed, with this upper base having many air circulation slots that, like a grate, allow the passing of the hot air that is emitted by the hot stones towards the food located on it. In addition, this internal box is also provided with lateral slots for aeration.

In this form of preferred embodiment, the container's main box is composed of a lower base, equipped with lateral aeration slots, situated so as to coincide with the lateral slots of the interior box, and an upper lid equipped with lateral aeration slots, also coinciding with the lateral slots of the lower base and of the interior box, as well as some aeration perforations in its upper base.

### DESCRIPTION OF THE DRAWINGS

In order to complement the description that is being made and with the aim of aiding a better understanding of the invention's characteristics, this descriptive report is accompanied, as an integral part thereof, drawings in which with an illustrative and non-limiting character, the following is represented:

FIG. 1. It shows a perspective view of an example of the thermal container for the transport of hot fast food, the purpose of the invention, which has been represented in an open position, noting the parts and elements that comprise it, as well as the configuration and their placement.

FIGS. 2 and 3. They show the view from above and the side view of the example of the container according to the invention shown in the preceding figure, in this case represented in the closed position, noting its general external configuration.

FIGS. 4 and 5. They show the view from above and side view of the internal box that constitutes the internal receptacle of the container used to hold the heat emitters, noting its configuration and parts.

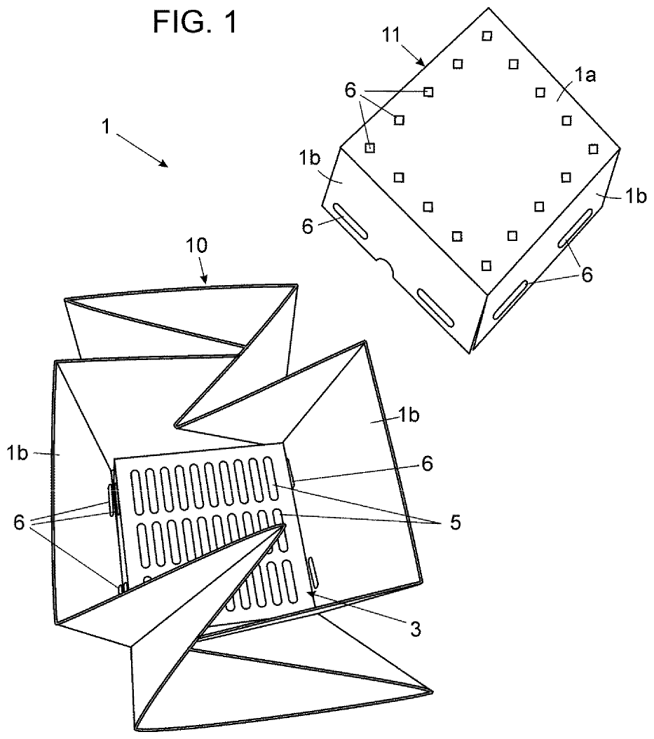

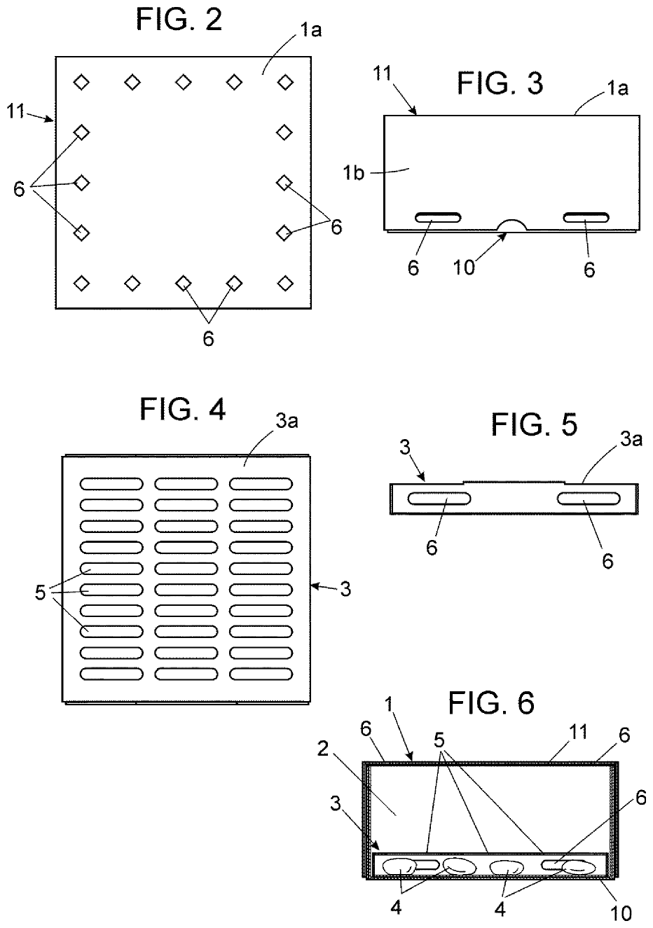

And FIG. 6. It shows a sectioned view, according to a vertical cross cut, of the example of the container, according to the invention, shown in the preceding figures, noting the incorporation of the hot stones in its internal box.

### PREFERRED EMBODIMENT OF THE INVENTION

In view of the mentioned figures, and in accordance with the adopted numeration, a non-limiting example of the embodiment of the thermal container for the transport of precooked hot fast food, which includes what is described below in detail.

As observed in the example shown in the figures, the container at issue, being made from at least one pre-cut laminated body and folded to form a main box (1) that defines an interior area (2) used to contain the food. It is distinguished by including in its interior an internal receptacle (3) provided to hold some heat emitters (4) such as, for example, hot stones, having been provided with a double ventilation system (5, 6) that ensures the circulation of air between the internal receptacle (3) and the interior area (2) of the main box (1) fostering the heat from the heat emitters (4), in this case the hot stones, to circulate towards the food, keeping it hot, and that also provides aeration towards the exterior, avoiding the condensation of the steam.

Preferably, this double ventilation system includes: some internal air circulation slots (5) provided in the internal receptacle (3), for example in the upper base (3a), in order to communicate the interior of this receptacle with the interior area (2) of the container's main box (1); and a series of external aeration slots and perforations (6) provided, at least, in the main box (1), for example, in the side walls (1b) and the upper base (1a) of this main box (1), which communicate the interior of both with the exterior.

In one form of embodiment, the main box (1) is of a laminated type of material and the internal receptacle (3) is of a different laminated material. And in another form of embodiment, both the main box (1) and the internal receptacle (3) are of the same laminated material, preferably of cardboard.

Preferably, the internal receptacle (3) is separate from the main box (1) which, also in the preferred mode, is placed on the interior base of said main box (1), but with less height, with its upper base (3a), which has multiple internal air circulation slots (5), defining the support surface on which the food will be placed. In addition, this separate box that forms the internal receptacle (3) is also provided with lateral slots for external aeration (6).

Preferably, the main box (1) is composed of a lower base (10) equipped with external aeration slots (6), located on its side walls (1b) and coinciding with the external aeration slots (6) of the sides of the box that defines the internal receptacle (3), and by an upper lid (11) equipped with external aeration slots (6) situated on the side walls (1b), also coinciding with the slots (6) of the sides of the lower base (10) and of the internal receptacle box (3), as well as external aeration perforations (6) in its upper base (1a).

In any case, the container can be of single use, where the main box (1) and the internal receptacle (3) are of the same material or of a different material, being formed from at least one pre-cut laminated body and folded, preferably of cardboard.

Having described sufficiently the nature of this invention, as well as the way to put it into practice, it is not considered necessary to extend its explanation so that any expert in the subject may understand its scope and the advantages that are derived from it, noting that, within its essence, it can be carried out in other forms of embodiment that differ in detail from that indicated as an example, and which will also be covered by the protection that is sought as long as they do not alter, change or modify its fundamental principle.

1. Thermal container for transporting hot fast food which, formed from at least one body that comprises a main box that defines an interior area used to contain food, is characterised in that it has in its interior an internal receptacle provided to hold heat emitters, having been provided with a double ventilation system that ensures the circulation of the air between the internal receptacle and the interior area of the main box (it leading to the circulation of heat from the heat emitters towards the food, keeping it hot, and that ensures the aeration towards the exterior, avoiding the condensation of steam.

2. Thermal container for transporting hot fast food, according to claim 1, wherein the double ventilation system is composed of internal air circulation slots provided in the internal receptacle to communicate the interior of this receptacle with the interior area of the main box tit and a series of external aeration slots and perforations provided, at least, in the main box and that communicate the interior of the latter with the exterior.

3. Thermal container for transporting hot fast food, according to claim 2, wherein the internal receptacle is a box which is separate from the main box.

4. Thermal container for transporting hot fast food, according to claim 3, wherein the internal receptacle is a separate box that is placed on the interior base of the main box, but of a lesser height, with an upper base, where many air circulation slots are incorporated, defining a support surface on which the food is placed.

5. Thermal container for transporting hot fast food, according to claim 4, wherein this separate box which forms the internal receptacle is provided with lateral aeration slots.

6. Thermal container for transporting hot fast food, according to claim 5, wherein the main box is composed of a lower base equipped with external aeration slots, situated in its side walls coinciding with the external aeration slots of the sides of the box that defines the internal receptacle, and by an upper lid equipped with external aeration slots situated in its side walls, also coinciding with the slots of the sides of the lower base and of the internal receptacle box, as well as external aeration perforations in its upper base.

7. Thermal container for transporting hot fast food, according to claim 1, wherein it is for single use.

8. Thermal container for transporting hot fast food, according to claim 1, wherein the main box and the internal receptacle are of the same material.

9. Thermal container for transporting hot fast food, according to claim 1, wherein the main box and the internal receptacle are of different materials.

10. Thermal container for transporting hot fast food, according to claim 1, wherein it is formed from at least one pre-cut and folded laminated body.

11. Thermal container for transporting hot fast food, according to claim 10, wherein the main box is made of cardboard.

12. Thermal container for transporting hot fast food, according to claim 1, wherein the heat emitters that are inserted in the internal receptacle are hot stones.
